(19) United States
(12) Patent Application Publication
(10) Pub. No.: US 2009/0144229 A1
(43) Pub. Date: Jun. 4, 2009

(54) STATIC QUERY OPTIMIZATION FOR LINQ

(75) Inventors: Henricus Johannes Maria Meijer, Mercer Island, WA (US); Amanda K. Silver, Seattle, WA (US); Paul A. Vick, Seattle, WA (US); Aleksey V. Tsingauz, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/948,078

(22) Filed: Nov. 30, 2007

(51) Int. Cl. G06F 7/06

(52) U.S. Cl. 707/2; 707/E17.017

(57) ABSTRACT

Systems and methods that optimize query translations at compile time in LINQ languages. An optimization component optimizes algebraic trees and rewrites an expression composed from sequence operators into a more efficient expression(s). A compiler associated with the optimization component can receive syntax (e.g., query comprehensions, query expressions) to turn into standard sequence operators that can operate on arbitrary collections. The compiler can then perform transformations on the algebraic trees, such as push filter conditions upwards or downwards and/or to combine filter conditions.

### BACKGROUND

Technology advancements and cost reductions over time have enabled computers to become commonplace in society. Enterprises employ computers to collect and analyze data. For instance, computers can be employed to capture data about business customers that can be utilized to track sales and/or customer demographics. Furthermore, individuals also interact with a plurality of non-enterprise computing devices including home computers, laptops, personal digital assistants, digital video and picture cameras, mobile devices, and the like. As a consequence of computer ubiquity, an enormous quantity of digital data is generated daily by both enterprises and individuals.

Computer operations are commonly performed through instruction sets generally referred to as a programming languages. Programming languages are conventionally based upon a common syntax that enables a programmer to write commands in the language, and are continuously evolving to facilitate specification by programmers as well as efficient execution. For example, in the early days of computer languages, low-level machine code was prevalent. With machine code, a computer program or instructions comprising a computer program was written with machine languages or assembly languages and executed by the hardware (e.g., microprocessor). Such languages provided an efficient procedure to control computing hardware, but were difficult for programmers to comprehend and develop sophisticated logic.

Subsequently, languages were introduced that provided various layers of abstraction. Accordingly, programmers could write programs at a higher level with a higher-level source language, which could then be converted via a compiler or interpreter to the lower level machine language understood by the hardware. Further advances in programming have provided additional layers of abstraction to allow more advanced programming logic to be specified much quicker then ever before.

Moreover, the state of database integration in mainstream programming languages leaves a lot to be desired. Many specialized database programming languages exist, such as xBase, T/SQL, and PL/SQL, but these languages have weak and poorly extensible type systems, little or no support for object-oriented programming, and require dedicated run-time environments. Similarly, there is no shortage of general purpose programming languages, such as C#, VB.NET, C++, and Java, but data access in these languages typically takes place through cumbersome APIs that lack strong antyping and compile-time verification. In addition, such APIs lack the ability to provide a generic interface to query data, data collections, and the like.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation optimizes query translations at compile time in Language-Integrated Query (LINQ) languages via an optimization component, which optimizes algebraic trees and rewrites an expression composed from sequence operators into a more efficient expression(s). In a related aspect, a compiler associated with the optimization component can receive syntax (e.g., query comprehensions, query expressions) to turn into standard sequence operators that can operate on arbitrary collections. The compiler can then perform transformations on the algebraic trees, such as push filter conditions closer to the leafs (e.g., downward or upwards)and/or to combine filter conditions. The filter conditions can reduce unnecessary projections (e.g., elimination at earliest stage) and “where” conditions can be optimized into join operations. Moreover, ordering and groupings can be pushed to end of operation or further up. As such, the optimization component can include: change of the order for iterating over collections, reflect nested iterations by joins, arbitrary nesting, pushing filter operations upfront, changing the orders therein, and the like.

According to a further aspect, the optimizer component can customize optimization process based on notions of collections being defined. Hence, type information can be collected to analyze the algebraic tree and gather information for optimization. Moreover, some algebraic optimization can hold true for any sequence operations. The compiler can evaluate different operations, wherein the compiler attempts to locate the operation that has minimum cost and is optimal. For different collection types, additional specific and/or customized rules can be valid based on the domain, which implement their own specific optimization rules (e.g., the collection being finite or infinite, size of the collection, multiple runs being involved and data that can be passed from runtime to compile time, child nodes involved in the query tree, and the like).

In a related methodology, the compiler operates on an algebraic tree and/or receives syntax, and subsequently performs a semantic analysis thereon. Results of the semantic can be presented as the sequence of nodes in form of the query tree, which can be transformed into sequence operator calls. In one aspect, the query syntax is translated into sequence operators, followed by a compile-time optimization phase that optimizes the code generated earlier. Such optimizations can be a combination of generic optimization rules, which typically can be valid for all implementations of the standard sequence operator pattern—in conjunction with domain specific optimizations that can be defined for a specific implementation of the standard sequence operators. Such rules and/or algebraic laws can be defined via employing a variety of methods such as custom attributes, special rewrite rules (e.g., expressed as queries themselves). Some of the optimizations can further employ feedback from instrumented runs of the program. Hence, the compiler can generate parse tree, to produce semantic analysis, wherein the results will be the query/query tree rather than sequence of calls. By building a query tree (based on semantics) and supplying multiple passes that provide for transformations, expressions can be simplified to optimize execution. It is to be appreciated that in addition to the static/compile-time optimization, the subject innovation can employ a run-time optimization pass that performs further optimization of (in-memory) queries based on statistics and operational characteristics of the collection type on which the LINQ query is executed.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an optimization component that operates in a Language-Integrated Query (LINQ) framework in accordance with an aspect of the subject innovation.

FIG. 2 illustrates an optimization component that optimizes algebraic and/or expression trees in accordance with an aspect of the subject innovation.

FIG. 3 illustrates a compiler associated with the optimization component according to an aspect of the subject innovation.

FIG. 4 illustrates a methodology of optimizing query translations at compile time in accordance with an aspect of the subject innovation.

FIG. 5 illustrates a related methodology of syntax translation according to an exemplary aspect of the subject innovation.

FIG. 6 illustrates a system that employs an implementation component according to an aspect of the subject innovation.

FIG. 7 illustrates an artificial intelligence (AI) or machine learning component that can be employed to facilitate implementing optimizations in accordance with an aspect of the subject innovation.

FIG. 8 is a block diagram depicting a compiler environment that can be employed to produce implementation code in accordance with the subject innovation.

FIG. 9 illustrates a schematic block diagram of a suitable operating environment for implementing aspects of the subject innovation.

FIG. 10 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

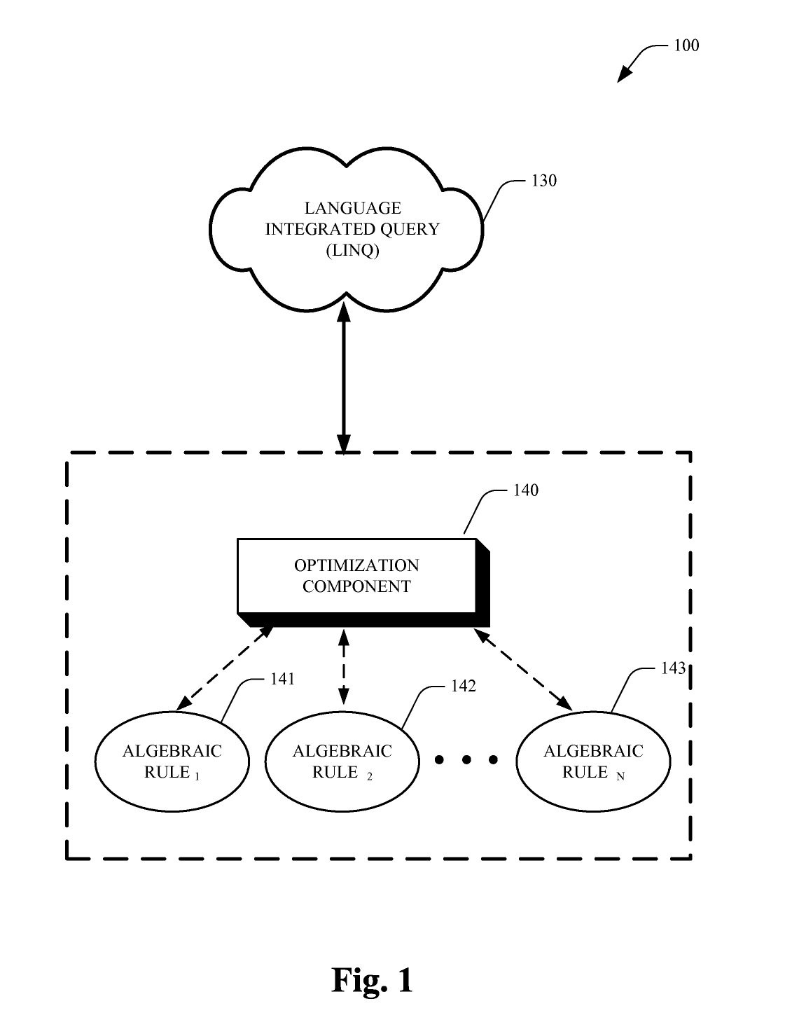

FIG. 1 illustrates a block diagram of an optimization component 140 that operates in a Language-Integrated Query (LINQ) framework 130 in accordance with an aspect of the subject innovation. Such optimization component 140 optimizes query translations at compile time in LINQ languages, to optimize algebraic trees and rewrites an expression composed from sequence operators into a more efficient expressions

In general, the LINQ framework 130 defines standard query operators that allow code written in LINQ-enabled languages to filter, enumerate, and create projections of several types of collections using the same syntax. Such collections can include arrays, enumerable classes, XML, datasets from relational databases, and third party data sources. Moreover, such can employ features of the .NET Framework, new LINQ-related assemblies, and extensions to the C# and Visual Basic .NET languages. For example, LINQ can be viewed as a set of features in that extends powerful query capabilities into the language syntax of C# and Visual Basic. The LINQ framework 130 can introduce standard, easily-learned patterns for querying and updating data, and can be extended to support potentially any type of data store, for example. LINQ can either access structures in memory or be translated into a remote call (e.g., in form of constructs that are familiar to developers who have worked with database queries, such as structured query language queries (e.g., SQL queries). Developers can use familiar clauses like ‘Where’ and ‘Order By’, just as they would with a database query and the collection will return an appropriate results.

The optimization component 140 can re-arrange clauses in the query and mitigate tasks of subsequent query operators. Accordingly, the optimization component 140 can facilitate supplying more intuitive ways of writing queries, wherein the optimization component 140 can then supply the proper replacement (e.g., nested operations being a more intuitive manner of a user can write syntax, which can be replaced by a join.) As such, rather than directly creating sequence operators from an algebraic tree, a pre-processing occurs via the optimization component based on algebraic rules 141, 142, 143 (1 to N, where N is an integer) that can be parameterized from external sources, or based on feedback from runtime operation and based on size differences between different collections.

The following instance indicates a particular operation for the optimization component 140 of the subject innovation, wherein conventional standard definition of translating query comprehensions is via a fixed set of rules. For example, operation of conventional systems for the following query

```
Dim Q = From X In Xs
        Where P(X)
        Where R(X)
        Select F(X)
```

is conventionally and blindly translated into the following sequence operator expression

Dim Q=Xs.Where(Function(X)P(X)).Where(Function(X)R(X)).Select(Function(X)F(X))

Such code is sub-optimal as it creates several unnecessary intermediate collection. The subject innovation can optimize such query into the following

Dim Q=Xs.Where(Function(X)P(X) AndAlso R(X)).Select(Function(X)F(X)))

Moreover, the subject innovation can further supply optimization, wherein an additional act to fuse the filter into the final selection can be provided

```
Dim Q = Xs.SelectMany(Function(X)
              If P(X) AndAlso Q(X)
              Return Singleton(F(X))
              Else
                Return Empty
              )
```

Since the standard sequence operators represent monads/monoids, an optimizer can employ typically all of the standard monad and monoid laws to optimize queries in conjunction with any other additional laws that are applicable for standard sequence operators that go beyond standard monads (such a join, grouping, sorting, and the like.) For example, the optimizer can replace a nested loop by a (hash) join.

In addition, each collection type can also provide domain specific optimization. For example, if it is known that a collection is a set, the optimizer can use the knowledge that the order of elements is irrelevant for example by reordering the iteration over collections

From X In Xs, Y In Ys→From Y In Ys, X In Xs Select X, Y

Or if it is known that a list is sorted, parts of a list may be skipped when doing a join.

Even if the order of the collection is important, the optimizer component 140 can employ algebraic properties of the various lambda expressions (such associativity, commutativity, idempotence, neutral elements, and the like) that are passed to the standard sequence operators to optimize queries.

In the example above, there exists a where node that has a left child “Xs” (the source collection) and as the right child a function as the predicate. Moreover, there exists another “where” on top of that there is a select, and such tree can be replaced with another tree that can be efficiently executed (e.g., with lower costs for execution). As indicated above, the second “where” clause and the second child can be pushed inside the predicate of the lowest “where” so the second tree can have the where with the “x” as the function, wherein there exists a select as the function, and thereupon exists combinations of the functions (p(x) and r(x)). Hence, instead of performing two “where” clauses only one “clause” can be performed. The final query can traverse the collection once and be performed efficiently, even though the results remains the same. Hence in general, a fixed translation is not employed from the source languages to the query operators, and instead an analysis is performed that employs general rules and customized rules that are specific to the type of collections, and also information based on previous runs.

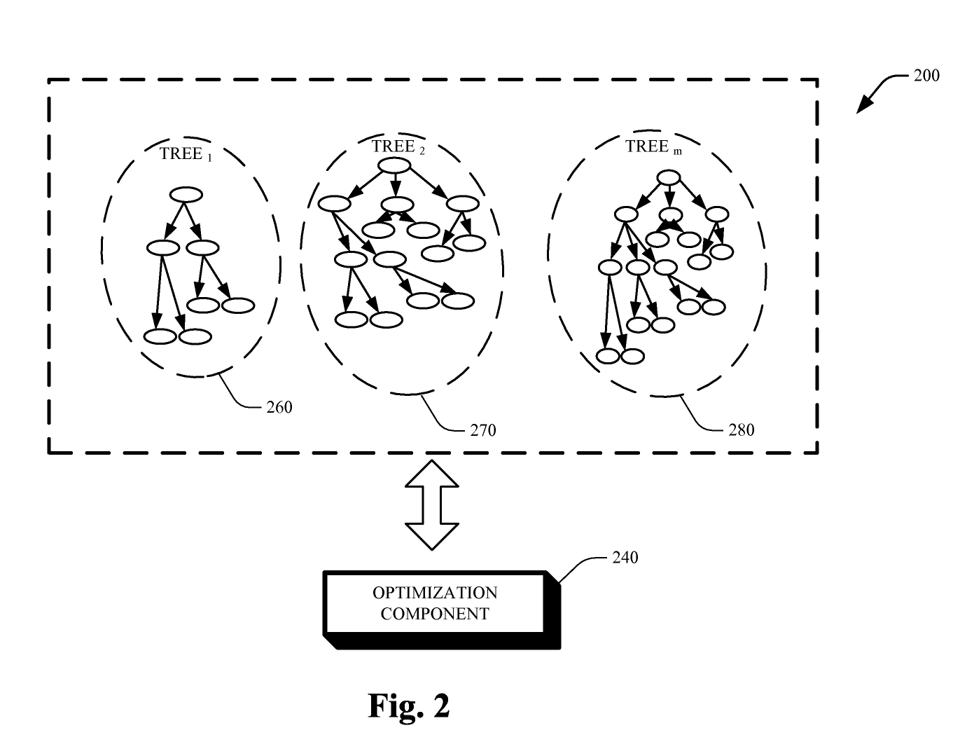

FIG. 2 illustrates an optimization component 240 that optimizes algebraic and/or expression trees 260, 270, 280 (1 thru m, m being an integer). As such, the optimization component 240 rewrites an expression composed from sequence operators into more efficient expressions.

Typically, trees 260, 270, 280 can represent the syntactic structure of a string according to some formal grammar, wherein the program that produces such trees is in form of a parser and the structure starts form a root node and end in leaf nodes (e.g., parent-child relations). For example, the expression tree representation allows any suitable query processor to implement data operations (Where, Select, SelectMany, a filter function, a grouping function, a transformation function, and the like) therewith. Such query processor allows data to be queried locally, remotely, over a wire, regardless of programming language and/or format, wherein the system 200 allows a representation of the query expression to be created, then send to the data and be allowed to be implemented remotely. Moreover, such data can be queried in a remote location the same as querying data in the memory of a local computer.

Upon creation of the expression tree representation, a query processor (not shown) can be implemented to provide a query result. As such the expression tree representation 260, 270, 280 can be employed by any suitable query processor(s) to allow for the querying of data. For example, the query processor(s) can be in form of “plug-in” to allow the utilization of any suitable query operation and/or data operation.

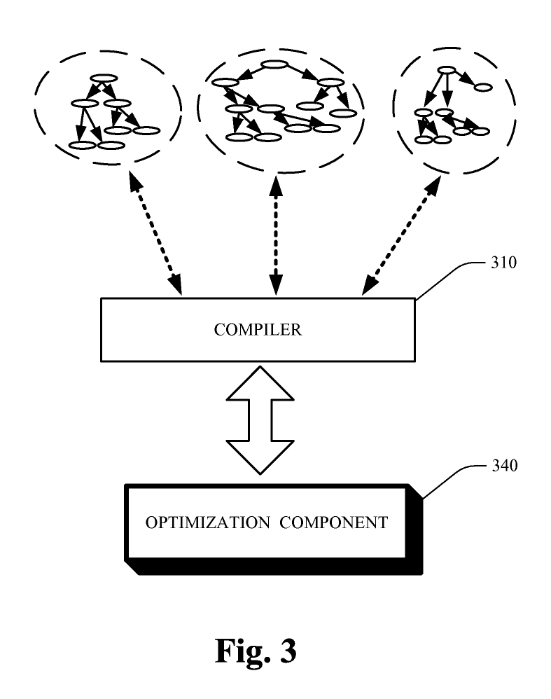

FIG. 3 illustrates a compiler 310 associated with the optimization component 340 according to an aspect of the subject innovation. The compiler 310 can receive syntax (e.g., query comprehensions, query expressions) to turn into standard sequence operators that can operate on arbitrary collections. The compiler 310 can also perform transformations on the algebraic trees, such as push and filter conditions upwards and/or to combine filter conditions. For example, the compiler 310 operates on an algebraic tree and/or receives syntax, and subsequently performs a semantic analysis thereon. Results of the semantic can be presented as the sequence of nodes in form of the query tree, which can be transformed into sequence operator calls. In one aspect, the query syntax can be translated into sequence operators, followed by a compile-time optimization phase that optimizes the code generated earlier. Such optimizations can be a combination of generic optimization rules, which typically can be valid for all implementations of the standard sequence operator pattern—in conjunction with domain specific optimizations that can be defined for a specific implementation of the standard sequence operators. Such rules and/or algebraic laws can be defined via employing a variety of methods such as custom attributes, special rewrite rules (e.g., expressed as queries themselves).

Some of the optimizations can further employ feedback from instrumented runs of the program. Hence, the compiler can generate parse tree, to produce semantic analysis, wherein the results will be the query rather than sequence of calls. By building a query tree (based on semantics) and supplying multiple passes that provide for transformations, expressions can be simplified to optimize execution. In addition to the static/compile-time optimization, the subject innovation can employ a run-time optimization pass that performs further optimization of (in-memory) queries based on statistics and operational characteristics of the collection type on which the LINQ query is executed.

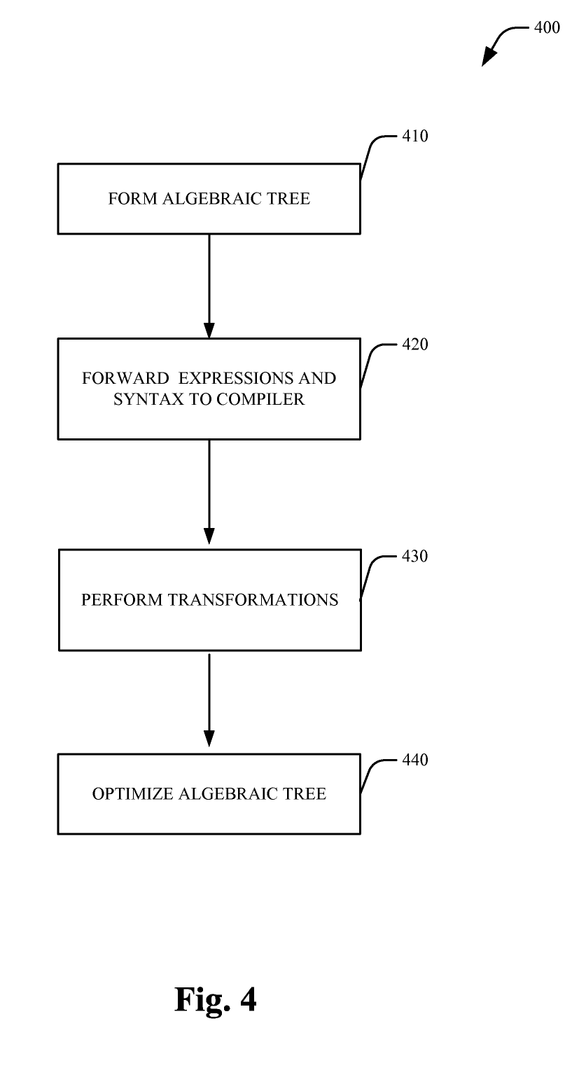

FIG. 4 illustrates a methodology 400 of optimizing query translations at compile time in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 410, a tree can be formed, to represent the syntactic structure of a string according to some formal grammar, for example. Next, and at 420 such a compiler that implements the optimization component of the subject innovation can receive such syntax (e.g., query comprehensions, query expressions) to turn into standard sequence operators that can operate on arbitrary collections. At 430, the compiler can perform transformations on the algebraic trees, such as push filter conditions upwards and/or to combine filter conditions, for example. Likewise, ordering and groupings can be pushed to end of operation or further up. As such, and at 440, optimizations can be obtained that include change of the order for iterating over collections, replacing reflect nested iterations by joins, arbitrary nesting, pushing filter operations upfront, changing the orders therein, and the like.

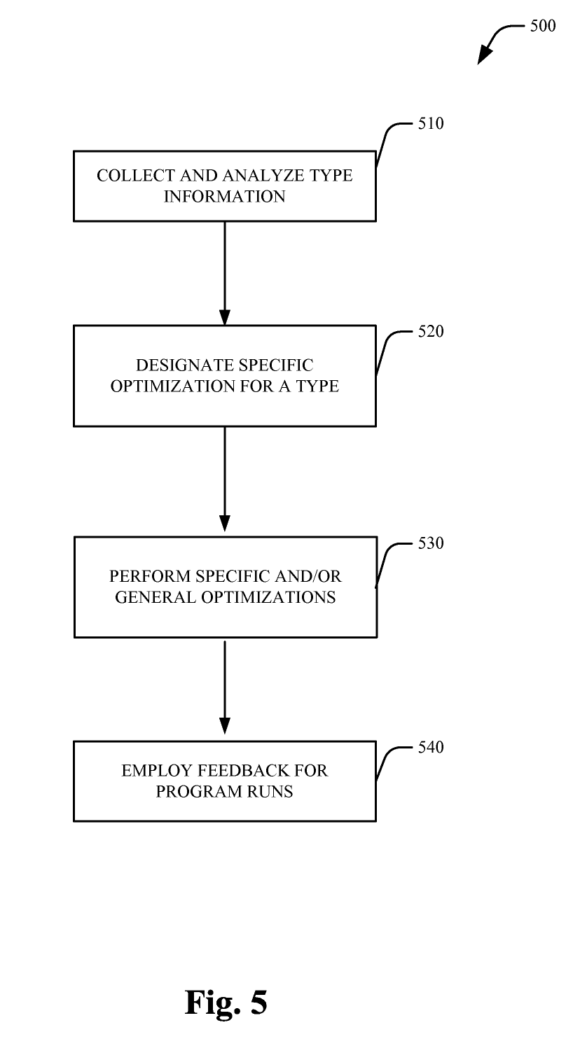

FIG. 5 illustrates a related methodology 500 of syntax translation according to an exemplary aspect of the subject innovation. Initially and at 510, type information can be collected and the types associated therewith analyzed. Next and at 520, for different collection types, additional and/or customized rules can be valid based on the domain, which implement their own specific optimization rules (e.g., the collection being finite or infinite, size of the collection, multiple runs being involved and data that can be passed from runtime to compile time, child nodes involved in the query tree, and the like). At 530, optimizations can be performed as a combination of generic optimization rules—which typically can be valid for all implementations of the standard sequence operator pattern—in conjunction with domain specific optimizations that can be defined for a specific implementation of the standard sequence operators. At 540, some of the optimizations can further employ feedback from instrumented runs of the program. Hence, the compiler can generate parse tree, to produce semantic analysis, wherein the results will be the query/query tree rather than sequence of calls. By building a query tree (based on semantics) and supplying multiple passes that provide for transformations, expressions can be simplified to optimize execution.

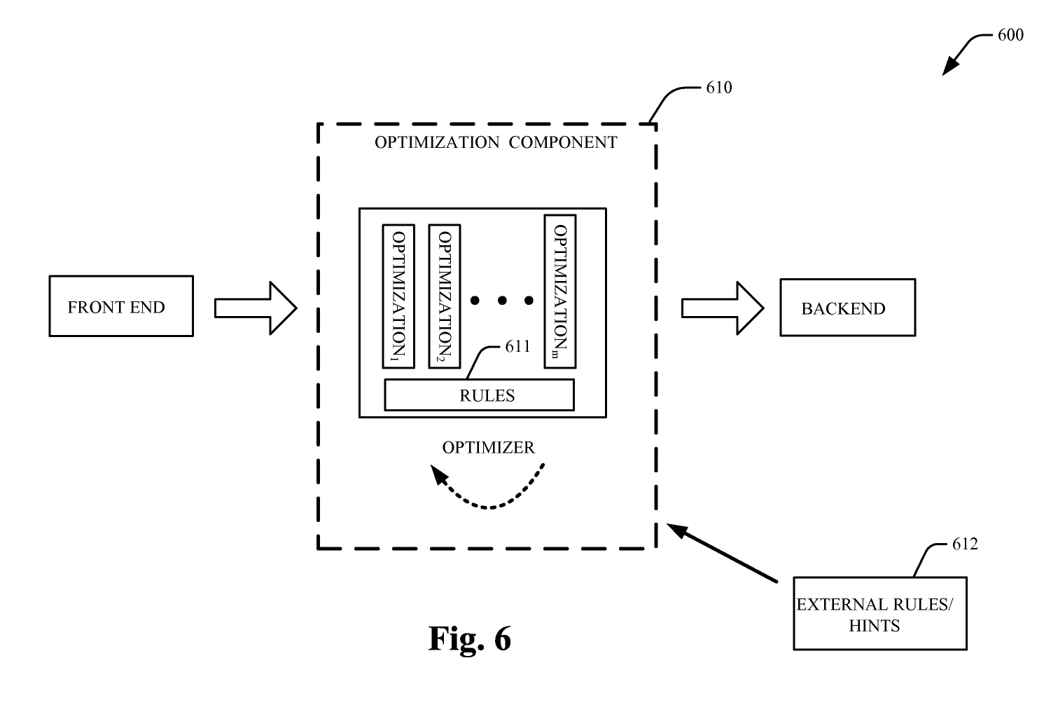

FIG. 6 illustrates a further system 600 that creates an expression tree representation to allow the implementation of a data operation by employing an optimization component 610 in accordance with an aspect of the subject innovation. The optimization component 610 can receive data, wherein a plurality of optimization(s) 1 to m can then be implemented. The optimization component can perform a plurality of operations, to include change of the order for iterating over collections, replacing nested iterations by joins, arbitrary nesting, pushing filter operations upfront, changing the orders therein, and the like. In the system 600, rather than directly creating sequence operators from an algebraic tree, a pre-processing occurs via the optimization component 610 based on algebraic rules 611 that can also be parameterized from external rules/hints 612, or based on feedback from runtime operation and based on size differences between different collections.

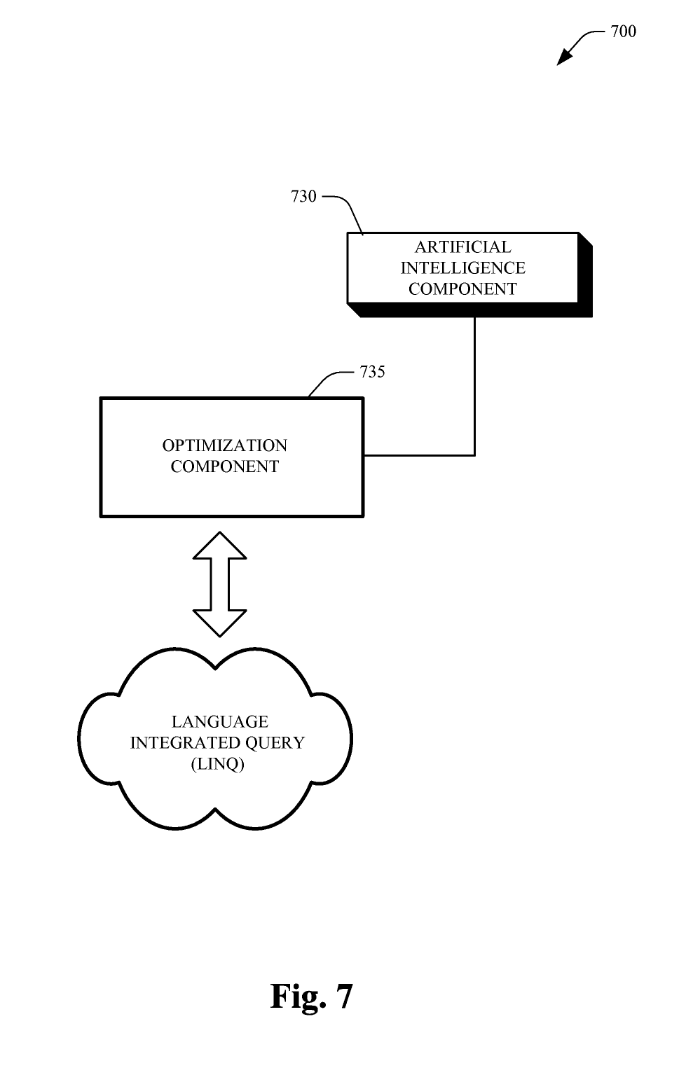

FIG. 7 illustrates an artificial intelligence (Al) or machine learning component 730 that can be employed to facilitate inferring and/or determining when, where, how to implement optimizations (e.g., based on general rules or customized rules) in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 730 can employ any of a variety of suitable AI-based schemes as described supra in connection with facilitating various aspects of the herein described invention. For example, a process for learning explicitly or implicitly how or which rule to employ can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

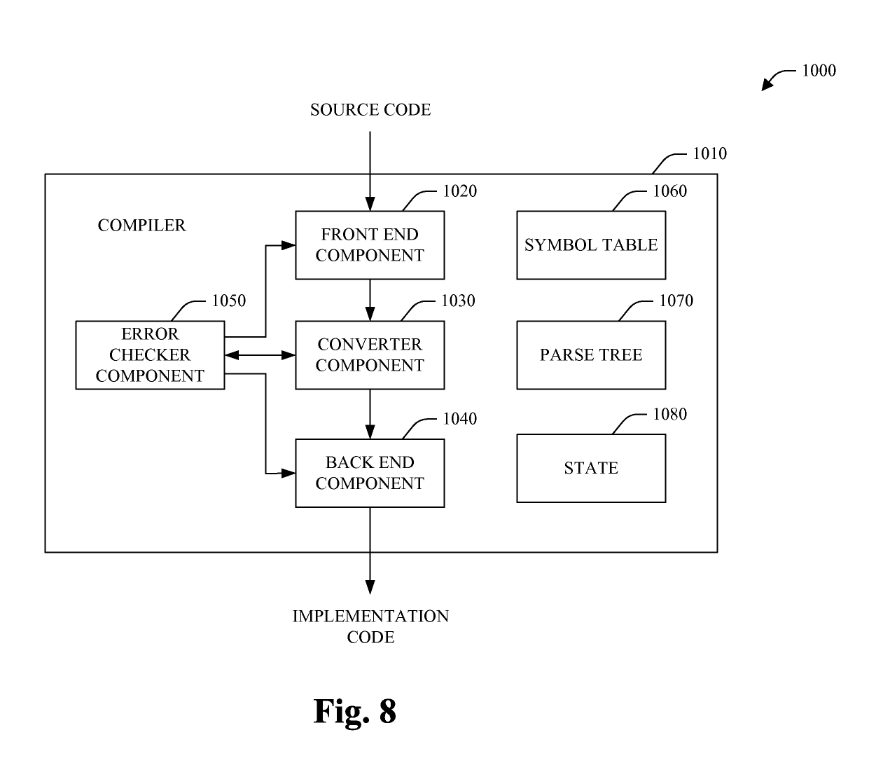

FIG. 8 is a block diagram depicting a compiler environment 800 that can be utilized to produce implementation code (e.g., executable, intermediate language . . . ) in accordance with the subject innovation. The compiler environment 800 includes a compiler 810 including a front-end component 820, a converter component 830, a back-end component 840, an error checker component 850, a symbol table 860, a parse tree 870, and state 880. The compiler 810 accepts source code as input and produces implementation code as output. The input can include but is not limited to delimited programmatic expressions or qualified identifier as described herein. The relationships amongst the components and modules of the compiler environment illustrate the main flow of data. Other components and relationships are not illustrated for the sake of clarity and simplicity. Depending on implementation, components can be added, omitted, split into multiple modules, combined with other modules, and/or other configurations of modules.

The compiler 820 can accept as input a file having source code associated with processing of a sequence of elements. The source code can include various expressions and associated functions, methods and/or other programmatic constructs. The compiler 820 may process source code in conjunction with one or more components for analyzing constructs and generating or injecting code.

A front-end component 820 reads and performs lexical analysis upon the source code. In essence, the front-end component 820 reads and translates a sequence of characters (e.g., alphanumeric) in the source code into syntactic elements or tokens, indicating constants, identifiers, operator symbols, keywords, and punctuation among other things. The converter component 830 parses the tokens into an intermediate representation. For instance, the converter component 830 can check syntax and group tokens into expressions or other syntactic structures, which in turn coalesce into statement trees. Conceptually, these trees form a parse tree 870. Furthermore and as appropriate, the converter module 830 can place entries into a symbol table 830 that lists symbol names and type information used in the source code along with related characteristics.

A state 880 can be employed to track the progress of the compiler 810 in processing the received or retrieved source code and forming the parse tree 870. For example, different state values indicate that the compiler 810 is at the start of a class definition or functions, has just declared a class member, or has completed an expression. As the compiler progresses, it continually updates the state 880. The compiler 810 can partially or fully expose the state 880 to an outside entity, which can then provide input to the compiler 810.

Based upon constructs or other signals in the source code (or if the opportunity is otherwise recognized), the converter component 830 or another component can inject code corresponding to facilitate efficient and proper execution. Rules coded into the converter component 830 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 860 and the parse tree 870, a back-end component 840 can translate the intermediate representation into output code. The back-end component 840 converts the intermediate representation into instructions executable in or by a target processor, into memory allocations for variables, and so forth. The output code can be executable by a real processor, but output code that is executable by a virtual processor can also be provided.

Furthermore, the front-end component 820 and the back end component 840 can perform additional functions, such as code optimization, and can perform the described operations as a single phase or in multiple phases. Various other aspects of the components of compiler 810 are conventional in nature and can be substituted with components performing equivalent functions. Additionally, at various stages during processing of the source code, an error checker component 850 can check for errors such as errors in lexical structure, syntax errors, and even semantic errors. Upon detection error, checker component 850 can halt compilation and generate a message indicative of the error.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

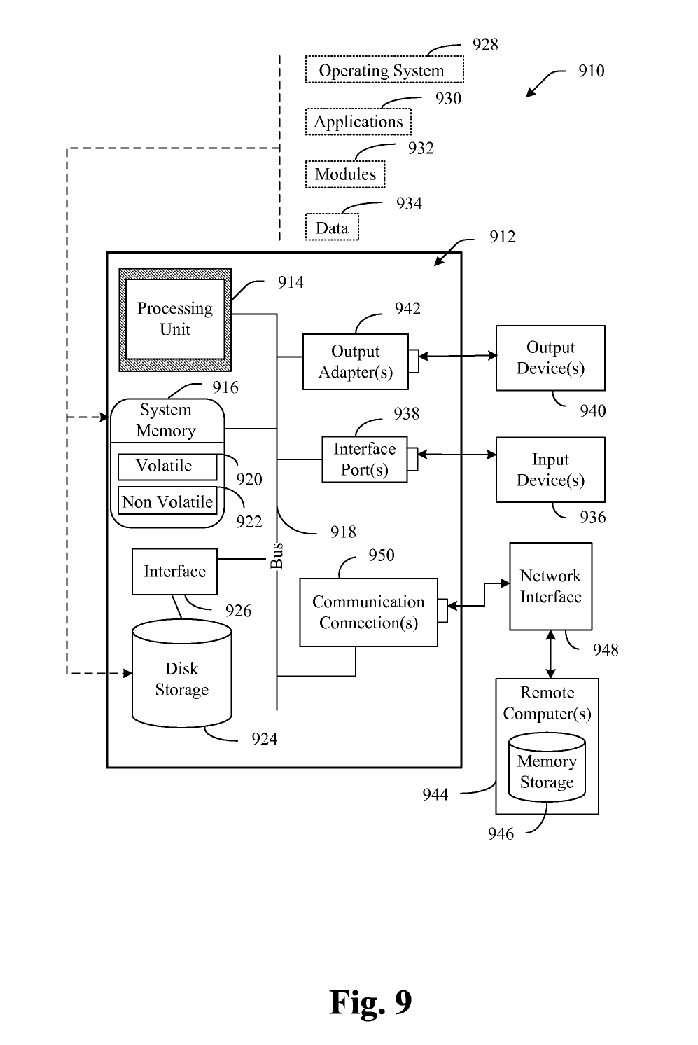

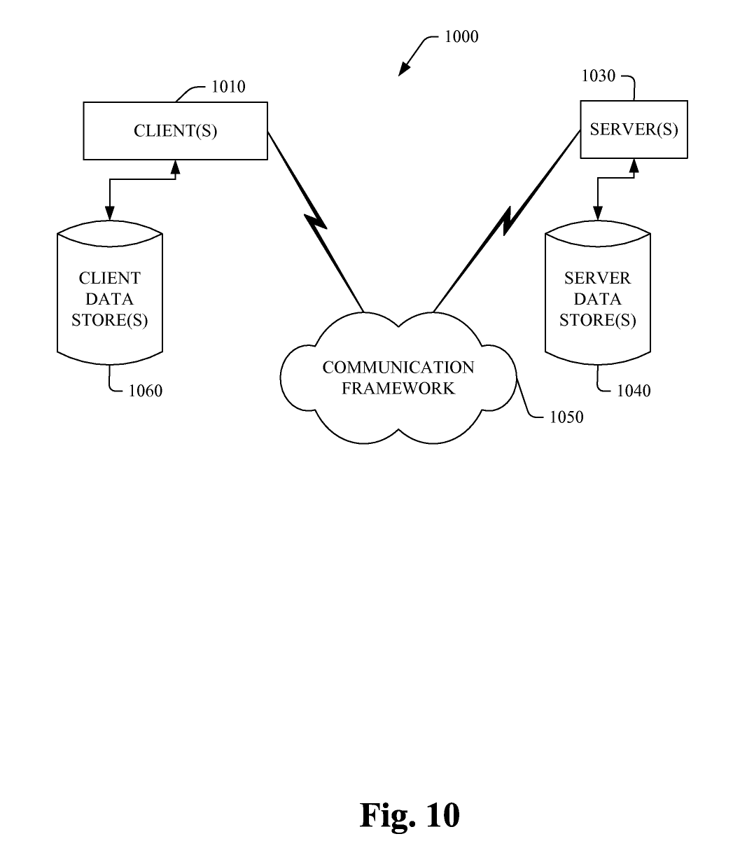

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a processing system of payment for downloaded digital content in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a plurality of expression trees that represent syntax associated with a Language-Integrated Query (LINQ); and
an optimization component that optimizes query translations based on the expression trees during compile time.

2. The computer implemented system of claim 1 further comprising a compiler that receives the expression trees.

3. The computer implemented system of claim 2, the compiler with filter conditions to mitigate projections and perform nesting operations.

4. The computer implemented system of claim 3, an operation of the compiler further customizable based on defined collections for data.

5. The computer implemented system of claim 4 further comprising generic compilation or optimization rules that are valid for all sequence operators.

6. The computer implemented system of claim 4 further comprising specific optimization rules that are valid based on domains.

7. The computer implemented system of claim 4 further comprising a feedback from instrumented runs of a program based on the LINQ.

8. The computer implemented system of claim 4 further comprising run time optimization passes performable on the query translation.

9. The computer implemented system of claim 4 further comprising an artificial intelligence or machine learning component that facilitates the optimizations.

10. A computer implemented method comprising:
receiving an algebraic tree or syntax associated with a LINQ via a compiler; and
optimizing the algebraic tree or syntax during compile time.

11. The computer implemented method of claim 10 further comprising performing a semantic analysis and transformations on the algebraic tree.

12. The computer implemented method of claim 11 further comprising changing iterations over collections or pushing filter operations upfront, or combination thereof.

13. The computer implemented method of claim 10 further comprising performing a run-time optimization of in memory queries.

14. The computer implemented method of claim 10 further comprising transforming syntax into sequence operators.

15. The computer implemented method of claim 10 further comprising supplying feedback from instrumented runs of the program.

16. The computer implemented method of claim 10 further comprising customizing rules based on domains.

17. The computer implemented method of claim 16 further comprising parameterizing algebraic rules based on external rules or hints.

18. The computer implemented method of claim 16 further comprising pushing filter operations upfront.

19. The computer implemented method of claim 16 further comprising inferring optimizations based on general rules or customized rules.

20. A computer implemented system comprising:
means for representing syntax as an expression tree associated with a Language-Integrated Query (LINQ); and
means for optimizing query translations based on means for representing syntax.
